(19) United States
(12) Patent Application Publication
(10) Pub. No.: US 2009/0106102 A1
(43) Pub. Date: Apr. 23, 2009

(54) STORAGE FACILITIES FOR EMERGENCY RELIEF SUPPLIES

(76) Inventor: James H. Johnson, JR., Lexington, KY (US)

Correspondence Address: KING & SCHICKLI, PLLC, 247 NORTH BROADWAY, LEXINGTON, KY, 40507, US

(21) Appl. No.: 11/996,759

(22) PCT Filed: Jul. 25, 2006
(86) PCT No.: PCT/US06/28760

§ 371 Date: Jan. 25, 2008

Related U.S. Application Data
(60) Provisional application No. 60/702,476, filed on Jul. 26, 2005.
(60) Provisional application No. 60/727,136, filed on Oct. 14, 2005.

(51) Int. Cl. G06Q 30/00; G06Q 99/00; F25D 23/00

(52) U.S. Cl. 705/14; 705/1

(57) ABSTRACT

A method of community service including placing a storage structure at a strategic location for direct distribution of emergency relief supplies from the storage structure to a populace in the event of an actual disaster. In addition the method includes marketing advertising on the storage structure.

The present invention claims the benefit of U.S. patent applications Ser. Nos. 60/702,476 filed 26 Jul. 2005 and 60/727,136 filed 14 Oct. 2005.

### TECHNICAL FIELD

The present invention relates to the field of public service and disaster relief.

### BACKGROUND OF THE INVENTION

Recent events including, particularly, the catastrophic destruction of New Orleans by Hurricane Katrina have highlighted a need for the establishment of emergency relief provision storage facilities in and around “at risk” population centers. Such facilities will provide a number of advantages including delivery of relief supplies to victims of a natural or other disaster in the immediate aftermath of the disaster. Advantageously this is accomplished while also alleviating some of the logistical problems in supplying tons of relief provisions to a stricken area. More specifically roads may be partially blocked or impassible following a disaster. Not only does this greatly limit or prevent people in need from reaching emergency supplies, it also greatly limits or prevents a relief agency from efficiently delivering emergency supplies. With emergency relief supplies on the ground at a location of need prior to the disaster, these problems are avoided.

The biggest hurdle to providing onsite storage facilities for relief provisions remains the cost of the building or storage structure. The present invention greatly reduces or eliminates these costs for the governmental agency or relief organization wishing to establish a relief provision storage facility at any particular location.

### SUMMARY OF THE INVENTION

In accordance with the purposes of the present invention described herein, a method of community service is provided. That method includes the steps of placing a storage structure at a strategic location for direct distribution of disaster relief supplies from that storage structure to a populace in the invent of an actual disaster. In addition the method includes the step of marketing advertising on the storage structure. Further the method may include stocking the storage structure with emergency relief supplies. Alternatively the method includes allowing a governmental entity or relief organization to stage emergency relief supplies in the storage structure.

The method may also include the placing of multiple storage structures at different strategic locations to form a network of storage structures to sustain a community in the immediate aftermath of an actual disaster. Such a method may include the acquiring of site placement rights for storage structures from one or more retailers. Further the method includes distributing relief supplies directly to the populace at the site of the storage structures.

In accordance with additional aspects of the present invention the method includes equipping a storage structure with one or more of a satellite telephone, a climate control unit, restroom facilities and/or an electric generator. Still further the method includes periodically replacing the emergency relief supplies stored in the storage structure with fresh supplies and donating the replaced emergency relief supplies to a charitable organization.

In accordance with yet another aspect of the present invention, a method of providing a storage structure to a government entity or private relief organization is provided. That method comprises the steps of placing the storage structure at a site selected by the government entity or private relief organization and leasing advertising space on the storage structure. The storage structure may be constructed from modular building materials and it may be anchored to the ground.

In the following description there is shown and described various embodiments of the invention, simply by way of illustration of some of the modes best suited to carry out the invention. As it will be realized, the invention is capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawing incorporated in and forming a part of this specification, illustrates several aspects of the present invention and together with the description serves to explain certain principles of the invention. In the drawing:

FIG. 1 is a perspective view of an emergency relief supply staging and/or storage structure; and

FIG. 2 is a schematical end elevational view of the structure of FIG. 1 through the open end doors

### DETAILED DESCRIPTION OF THE INVENTION

In accordance with the present invention, a method of public or community service is provided. That method includes the steps of placing a storage structure in a strategic location for direct distribution of emergency relief supplies from the storage structure to the populace in the event of an actual disaster and the marketing of advertising on the storage structure. The method may further include the stocking of the storage structure with emergency relief supplies and/or the allowing of a governmental entity or relief organization to stage emergency relief supplies in the storage structure. The supplies may be stored in the storage structure for the long term, such as for the entire hurricane season. At the end of the season they could be removed and given to a charitable organization. In the alternative, the storage structure could be left empty and only stocked with relief supplies when a hurricane is expected to make landfall in a given area near the structure. In either approach, the supplies are on the ground at a disaster site before the disaster occurs. The structure itself is sufficiently strong to protect the supplies during the disaster.

Still further the method includes placing multiple storage structures at different strategic locations so as to form a network of storage structures. Such a network is capable of sustaining a community in the immediate aftermath of an actual disaster. More specifically, this is accomplished by distributing the emergency relief supplies directly from the structures to the populace. Since the emergency relief supplies are already on the ground in the stricken area before the disaster they are immediately available. This avoids the logistics problems of moving supplies into the area after the disaster when roads may be blocked and impassable and many people are stranded without means of transportation.

The method may also include acquiring a site placement right for a storage structure from a retailer. Preferably, the storage structure is equipped with one or more of the following: a satellite telephone, a climate control unit such as an air conditioner, refrigerator or freezer, restroom facilities including a toilet, a sink and preferably a shower and an emergency electric generator.

The method further includes periodically replacing the emergency relief supplies stored in the storage structure with fresh supplies. The replaced supplies may then be donated to a charitable organization for use.

In accordance with an additional aspect of the present invention a method of providing a storage structure to a governmental entity or private relief organization is provided.

In accordance with another embodiment of the present invention, a semipermanent building is erected at a desired site on land owned, donated or dedicated to the government entity or relief organization. The building provides the governmental entity or relief organization with storage space for relief supplies such as clean water, medicine, blankets, clothing, food and other necessities. Such buildings may be located in or around high risk sites for natural disasters such as in and around hurricane prone cities along the Gulf and Atlantic coasts, earthquake prone areas such as in and around San Francisco and tornado prone areas such as found in Kansas, Oklahoma and Texas. In accordance with the present invention the semipermanent building is erected on the property of the government entity or relief agency at nominal or no cost to the agency. Such locations may include land donated to, owned or otherwise controlled by the entity or agency including, for example, land loaned for that purpose by private entities such as a suitable space at a shopping mall.

More specifically, the method may be broadly described as comprising providing the governmental entity or agency with a selection of semipermanent, standardized building options and erecting the semipermanent building at a site selected by the governmental agency or relief agency. The method may also include the positioning of the semipermanent building on a blacktop or concrete pad and the anchoring of the building to the ground through the blacktop or concrete pad. In addition, the method includes displaying advertising on the semipermanent building. That advertising may be in the form of conventional signage or the like or even digital graphics. Further, the advertising is rotated on the semipermanent building as may be necessary to meet local ordinances. The money generated by the advertising is utilized by the building provider to offset the cost of the building which is provided to the government agency or relief organization at nominal or no cost.

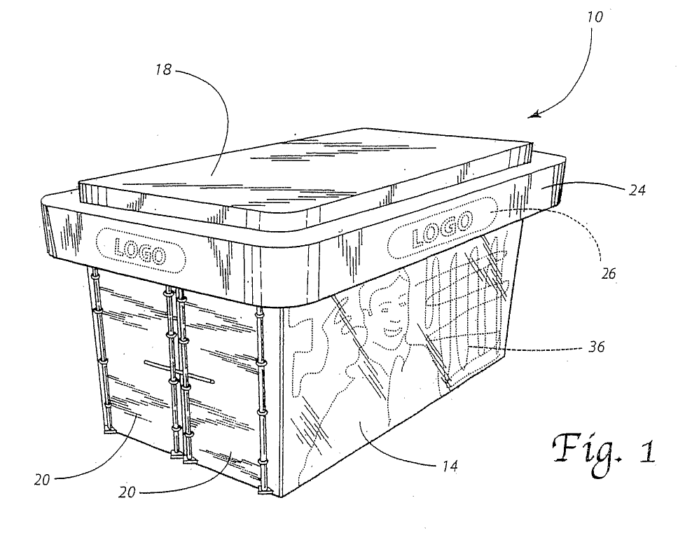

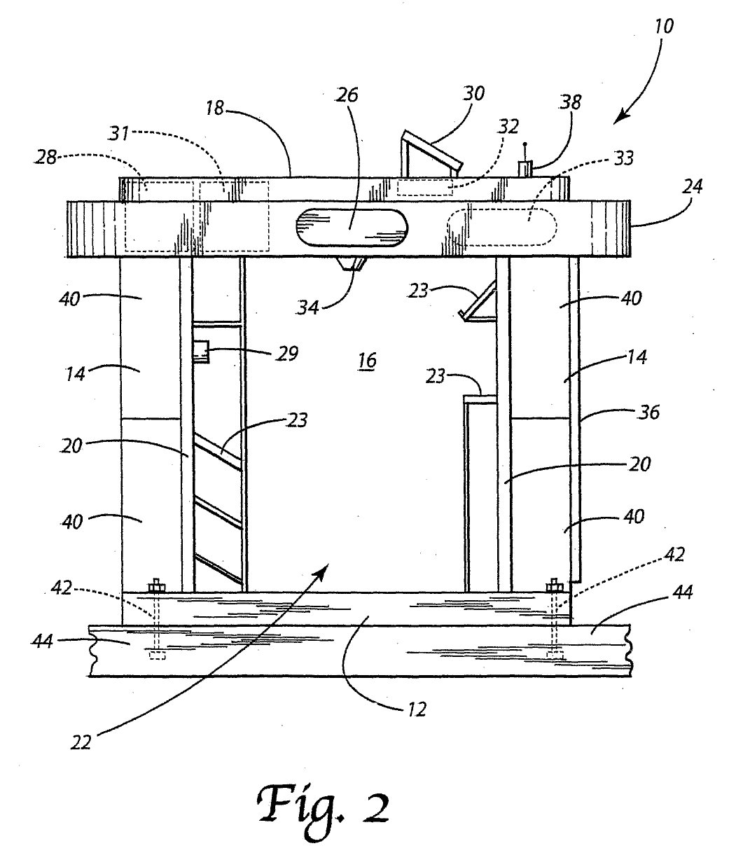

In accordance with one possible aspect of the present invention, the method may include prefabricating the semipermanent building or constructing the semipermanent building or storage structure from prefabricated building panels. More specifically, as illustrated in FIGS. 1-2 the structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior space 22. That space 22 may be customized to meet any special needs for storing or staging emergency relief supplies such as water, food, baby formula, diapers, first aid kits, medicine, blankets, tents, bedding communications equipment such as walkie talkies and satellite telephones, and the like.

Similarly, the exterior of the structure 10 may be customized to match the trade dress of substantially any desired party and/or architectural features of any building near which the structure 10 may be placed into service. Thus, for example, the structure 10 may include a decorative roof cap 24 sized and shaped to a user's specifications. The roof cap 24 may include advertising, trade dress or logo 26 if desired and/or as allowed by local regulations.

The structure 10 may also be equipped with various electrical and/or mechanical systems. For example, a climate control unit 28 such as an air conditioner, refrigerator or freezer may be provided on the structure 10 in order to provide climate control of a portion or all of the space 22 within the storage structure. For example, bottled water may be stored in an air conditioned or refrigerated unit. Ice may be stored in a structure 10 equipped with a freezer unit.

In addition, the structure 10 may include an electrical box 29 that may be connected to the line of the local electric utility company. Alternatively or in addition, the structure 10 may be equipped with a solar panel 30 and cooperating battery 32 to store energy for powering an internal lighting system 34 for illuminating the space 22. Still further, the structure may include an emergency power source such as an electric generator 31 run by an internal combustion engine, natural gas, propane (note propane storage tank 33) or even a fuel cell. Such a power source could be used to power a radio transmitter 35, a speaker system or the like provided on the structure to broadcast an emergency message. Such a message could include, for example, directions to the nearest tent city or emergency relief resupply station.

The structure 10 may be constructed, for example, from modular building materials such as prefabricated panels 40 of the type shown and described in, for example, U.S. Pat. No. 6,279,287 to Meadows, U.S. Pat. No. 5,373,678 to Hesser and U.S. Pat. No. 6,119,427 to Wyman et al. Such modular panels 40 typically incorporate a core of thermal insulating material sandwiched between metal or plastic sheathing. Such a construction provides both efficient and effective control of the temperature and humidity of the environment in the internal space 22 and excellent inclement weather durability for a long, low-maintenance service life. Structures 10 constructed from such modular building panels 40 are also characterized by high strength and will resist high winds and maintain a weather-tight enclosure to protect products held in the space 22 from inclement weather. In fact, such structures may be easily anchored to the ground such as by means of cooperating nut and bolt anchors 42 where the bolt is received and held in an underlying poured concrete pad 44. Such structures may be specifically designed to withstand winds associated with Category 3, Category 4 or even Category 5 hurricanes as desired. The modular panels 40 also allow the structure 10 to be quickly and easily erected and subsequently removed in a minimal amount of time while producing a minimum of mess.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the door 20 may be provided in the side wall 16 rather than the end wall. Further, more than one set of doors 20 may be provided if desired. The structure could also include a tap connected to the public water supply. Still further, the structure could include a toilet and a shower connected to the public water supply and waste lines.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of community service, comprising:
placing a storage structure at a strategic location for direct distribution of emergency relief supplies from said storage structure to a populace in event of an actual disaster; and
marketing advertising on said storage structure.

2. The method of claim 1, including stocking said storage structure with emergency relief supplies.

3. The method of claim 1, including allowing a governmental entity or relief organization to stage emergency relief supplies in said storage structure.

4. The method of claim 1, including placing multiple storage structures at different strategic locations so as to form a network of storage structures to sustain a community in immediate aftermath of an actual disaster.

5. The method of claim 1, including acquiring site placement rights for a storage structure from a retailer.

6. The method of claim 1, including distributing relief supplies directly to the populace at the site of said storage structure.

7. The method of claim 1, including equipping said storage structure with a satellite telephone.

8. The method of claim 1, including equipping said storage structure with a climate control unit.

9. The method of claim 1, including equipping said storage structure with rest room facilities.

10. The method of claim 1, including equipping said storage structure with an electric generator.

11. The method of claim 1, including periodically replacing emergency relief supplies stored in said storage structure with fresh supplies.

12. The method of claim 11, including donating said replaced emergency relief supplies to a charitable organization.
